(19) United States
(12) Patent Application Publication
(10) Pub. No.: US 2012/0297310 A1
(43) Pub. Date: Nov. 22, 2012

(54) SHOP FLOOR INTERACTION CENTER

(75) Inventor: Boaz Katabi, Ganey Tikva (IL)

(73) Assignee: Limont Group Inc., Tortola (VG)

(21) Appl. No.: 13/519,596

(22) PCT Filed: Dec. 29, 2010
(86) PCT No.: PCT/IB10/56113

§ 371 Date: Jun. 28, 2012

Related U.S. Application Data
(60) Provisional application No. 61/290,546, filed on Dec. 29, 2009.

(51) Int. Cl. G06F 3/01

(52) U.S. Cl. 715/738

(57) ABSTRACT

A system and method for simplifying communication between a user and an Enterprise Resource Planning (ERP) system, including a User-Facing Module (UFM) for managing user interactions and a ERP Mirror Module (EMM) for temporarily storing and organizing data from the ERP system to enable the user interaction.

This is a continuation-in-part of U.S. Provisional Patent Application No. 61/290,546, filed Dec. 29, 2009

### FIELD AND BACKGROUND OF THE INVENTION

The present invention relates to a control system for production-floor processes and, more particularly, to an user friendly interface system which mirrors large scale Enterprise Resource Planning (ERP) systems such as SAP and Oracle, while providing a flexible and easy to use and customize interface.

An ERP system is an integrated computer-based application used to manage internal and external resources, including tangible assets, financial resources, materials, and human resources. Its purpose is to facilitate the flow of information between all business functions inside the boundaries of the organization and manage the connections to outside stakeholders. Built on a centralized database and normally utilizing a common computing platform, ERP systems consolidate all business operations into a uniform and enterprise-wide system environment.

Businesses have a wide scope of applications and processes throughout their functional units, producing ERP software systems that are typically complex and usually impose significant changes on staff work practices. Implementing ERP software is typically too complex for in-house developers, lacking the required skills, so it is desirable and advisable to hire outside consultants who are professionally trained to implement these systems. This is typically the most cost-effective way. There are three types of services that may be employed—Consulting, Customization, and Support. The length of time to implement an ERP system depends on the size of the business, the number of modules, the extent of customization, the scope of the change, and the willingness of the customer to take ownership for the project. ERP systems are modular, so they do not all need be implemented at once. Implementation can be divided into various stages, or phase-ins. A typical project is about 14 months and requires around numerous consultants: “The average length of time for a “typical” implementation is about 14 months and can take as much as 150 consultants. Corning, Inc. plans to roll out ERP in ten of its diversified manufacturing divisions, and it expects the rollout to last five to eight years” (“Critical Issues Affecting An ERP Implementation”, http://carl.sandiego.edu/gba573/critical_issues _affecting_an_erp.htm). A small project (e.g. a company of less than 100 staff) can be planned and delivered within 3-9 months; however, a large, multi-site or multi-country implementation can take years. The length of the implementations is closely tied to the amount of customization desired.

Today, SAP AG [Systemanalyse and Pro grammentwicklung (“System Analysis and Program Development”)], based in Walldorf, Germany has the leading control system for production floor processes SAP ERP (referred to simply as ‘SAP’ herein) and is used across the board in manufacturing processes. Unfortunately this system is rigid and difficult to adapt to specific customer requirements. For example, the creation or modification of report screens relating to a production process is very complex. SAP currently has a system for managing production-floor reports called Pi-Sheet. This system has very limited functionality and is inflexible and difficult to use. In order for an organization to customize a particular reporting screen to satisfy their specific needs as dictated by the particular work methods, it is necessary to employ programmers skilled in SAP customizations or dedicate in-house resources in a costly and time consuming manner. The same is true for other large scale ERP systems such as the ERP system of Oracle Corporation based in California, USA.

It would be highly advantageous to have a system whereby ERP reporting screens can be created by non-technical top-end users, with a user-friendly, flexible interface. It would be further advantageous to have a system which significantly expedited ERP implementation (e.g. on the scale of for prior methods for implementation taking one year to the equivilent implementation taking two weeks).

### SUMMARY OF THE INVENTION

The system of the current invention, called a Shop Floor Interaction Center (SFIC), allows for the creation of customized reporting screens for different processes in a manufacturing plant which uses an ERP system. This innovative system is essentially an easy-to-use, flexible customer interface which sits “on top” of the ERP system (such as SAP, Oracle). The necessary reporting screens can be created by non-technical top-end users, specifically for process(es) relevant to the user. The SFIC system draws information from the ERP system/database and displays this information in accordance with the parameters defined by the client. Whereas the prior art systems, such as SAP PI(Process Integration)-Sheet® reporting system, are inflexible and demand a high skill-level intervention to customize report screen and parameters equaling hundreds of hours of R&D and/or professional implementation, SFIC is extremely user-friendly and allows for the simple creation of report screens in an extremely expedited manner. The equivalent of one year of man-hours currently needed to research, program and implement customizations can be completed utilizing two weeks of man-hours on the SFIC system.

SFIC fully supports SAP's PP-PI (Production Planning for Process Industries) and PP production modules for process-based production and unit production respectively. The system also fully supports Oracle's ERP system.

Some preferred embodinments of the innovative system use Microsoft .Net® tools whereas other embodiments use Java®, C++®, or other programming tools.

According to the present invention there is provided a system for simplifying communication between a user and an Enterprise Resource Planning (ERP) system, including: (a) a User-Facing Module (UFM) operable to send user-data, received from the user, to the ERP system; and interact with ERP-data substantially equivalent to parallel data in the ERP system; and (b) an ERP Minor Module (EMM), for temporarily storing the ERP-data, received from the ERP system, and organizing the ERP-data so as to enable the interaction with the UFM.

According to further features in preferred embodiments of the invention described below the EMM includes a group of at least one temporary file containing a set of at least one record having a set of at least one data field, wherein each at least one data field contains data substantially equivalent to data in a respective parallel data field in the ERP system.

According to still further features in the described preferred embodiments the UFM has: (a) a Configuration Mode, for configuring at least one reporting screen; and (b) an Application Mode, for effecting the interaction with the ERP data using the at least one configured reporting screen.

According to still further features in the described preferred embodiments each said at least one reporting screen that is configured is selected from the group consisting of a new reporting screen and a pre-configured reporting screen.

According to still further features in the described preferred embodiments the configuring of the at least one reporting screen includes the steps of: (A) customizing at least one reporting field, in the reporting screen; and (B) logically connecting each at least one reporting field to a respective data field temporarily saved in the EMM.

According to still further features in the described preferred embodiments when in the Application mode, the interaction includes at least one action selected from the group of: (i) receiving user-data from the user; (ii) outputting the ERP-data from the EMM; (iii) manipulating the user-data; and (iv) manipulating the ERP-data.

According to still further features in the described preferred embodiments the user-data is data selected from the group of: (i) a data request (DR) for requesting data from the ERP system, and (ii)a data update (DU) for updating data on the ERP system.

According to still further features in the described preferred embodiments the sending of the user-data includes the steps of: (i) converting the user-data into an ERP-recognized data set; and (ii) sending the ERP-recognized data set to the ERP system via an ERP recognized data transfer service.

According to still further features in the described preferred embodiments the receiving of the ERP-data from the ERP system by the EMM includes the steps of: (i) receiving an ERP recognized data set sent via the ERP recognized data transfer service; and (ii) organizing the ERP recognized data set into ERP-data useful to the UFM.

According to still further features in the described preferred embodiments the ERP-recognized data set is a Business Application Programming Interface (BAPI) and the data transfer service is a web service of an Application Server.

According to the present invention there is provided a method of simplifying communication between a user and an Enterprise Resource Planning (ERP) system, including the steps of: (a) mapping the ERP system; (b) categorizing relevant elements mapped on the ERP system; (c) for each category, creating a record containing a set of at least one data field; and (d) copying parallel data from the ERP system to the set of at least one data field.

According to further features in preferred embodiments of the invention described below the method further includes the steps of: (e) configuring a reporting screen having a group of at least one reporting field; and (f) logically connecting each of the at least one reporting field to a respective data field.

According to still further features in the described preferred embodiments the method further includes the step of: (g) manipulating said copied parallel data via said group of at least one reporting field.

### BRIEF DESCRIPTION OF THE DRAWINGS

Various embodiments are herein described, by way of example only, with reference to the accompanying drawings, wherein:

FIG. 1 is a high-level flow chart of an overview of the interaction between an embodiment of the innovative system and an exemplary ERP system;

FIG. 2 is a depiction of the innovative system in Configuration Mode;

FIG. 3 is a depiction of the innovative system in Application Mode.

### DESCRIPTION OF THE PREFERRED EMBODIMENTS

The principles and operation an improved system and method for communicating with an ERP system according to the present invention may be better understood with reference to the drawings and the accompanying description.

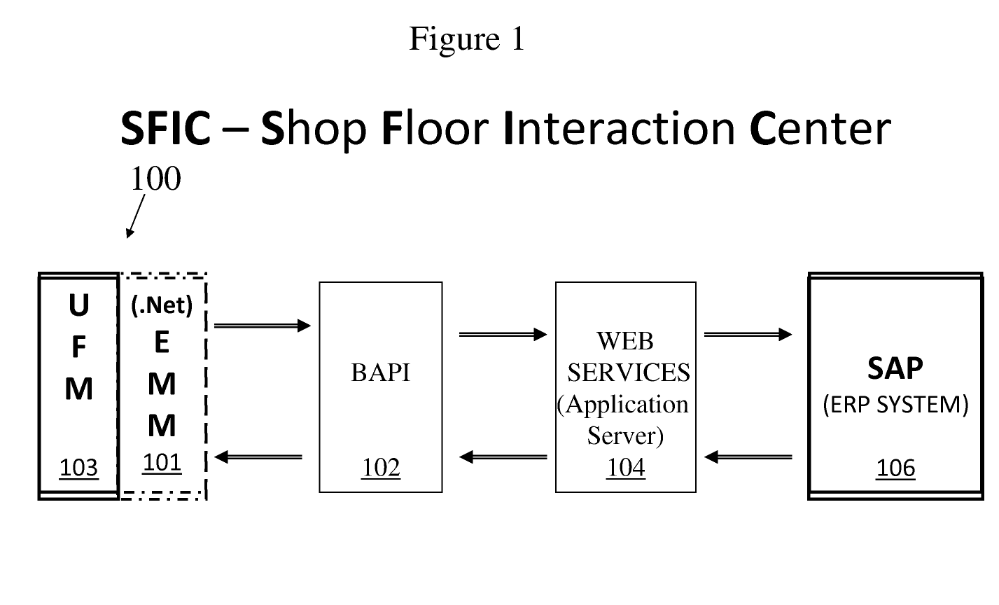

Referring now to the drawings, FIG. 1 illustrates a high-level overview flow chart detailing the interaction between an embodiment of the SFIC system 100 and the SAP ERP system 106. The current flow chart contains exemplary components (.NET, BAPI, web services, SAP), making use of the most common ERP systems in use today, although the innovative system is equally adapted to other ERP systems (e.g. ERP system of Oracle®).

The SFIC system 100 is primarily made up of two main modules, a User Facing Module (UFM) 103 and an ERP Minor Module (EMM) 101. UFM 103 is the user interface visible to the user. For the sake of clarity, the term ‘user’, as referred to in the scope of this invention, does not necessarily refer to a human user, but also includes any automated system which accesses the functionality of the current system in a manner similar to that of a human user. UFM 103 allows the user to input data, known as user-data, into the system. The user data generally takes the form of update data (UD) or a data request (DR). Update data is data inputted in order to update the ERP system with the most current information. Data requests are queries sent to the ERP system for data currently stored in the ERP system. UFM 103 also affords all the functionality of viewing/interacting with/manipulating the ERP-data (data originating in the ERP system, or substantially equivalent to parallel data in the ERP system) in order to effect actions such as data manipulation, calculations, presenting/displaying/printing reports, graphs, labels, etc.

The innovative ERP Mirror Module (EMM) 101 is not visible to the user. In some embodiments of the current invention, EMM 101 is a system created by the Microsoft .NET® programming tool (and referred to herein as a .NET system). In other embodiments, the EMM is a JAVA system, a C++ system, or any similar system created by a similar programming tool. EMM 101 contains a group of logic files stored in temporary memory. Each file contains a set of records pertaining to relevant categories of data found on the ERP system. The relevant categories are derived from mapping the ERP system, focusing on elements relating to ‘products and manufacture’ in the ERP system as applied to shop floor interaction (as the specific example presented here). The innovative method and system can be similarly applied to any other area of the ERP system, such as, but not limited to: Supply chain management, Financials, Project management, Human resources, Customer relationship management, Data services, Access control. Once mapped, the relevant elements are organized into categories. In EMM 101 each record contains a set of fields (termed ‘data fields’ to distinguish them from ‘reporting fields’ found in the reporting screens discussed below). In use, data from the ERP system is copied to the parallel data-field so that each data field contains data which is substantially equivalent to parallel data in the ERP system.

Exemplarily, a user enters user data (UD) on a relevant (pre-/user configured) screen (detailed below) on UFM 103 of SFIC system 100. The data entered queries the .NET mirror EMM 101 for a response from SAP. EMM 101 has temporary files or at least one temporary file containing at least one record having at least one data field (explained in further detail below) which reflect the data in the SAP system. If the UD is a data request (DR), EMM 101 converts the user request into an ERP-recognized data set. In some embodiments of the invention and in the current exemplary illustration, the ERP-recognized data set is a Business Application Programming Interface (BAPI) 102. BAPIs are the standardized programming interface enabling external applications to access business processes and data in the SAP System. The BAPI is sent online over the Internet/intranet (or organizational network or network of networks) to SAP via an Application Server using Web Services 104 (or some similar ERP-recognized service for data transmittal over a network or network of interconnected networks). The BAPI extracts the necessary information from SAP and returns the requested data, ERP Data (ED), via the web services to EMM 101, using a BAPI. The BAPI returns the ED to the EMM 101, which is organized according the relevant categories and in turn distributes the data to the relevant UFM (user configured) reporting screen(s). The user working on the SFIC system can conduct relevant activities as if the SFIC system is conversing on-line with the SAP system directly, by accessing and manipulating substantially equivalent data in EMM 101 which has been copied from the ERP system and temporarily stored on EMM 101.

The ability to update or received updated information online in real-time from SAP is innovative to the current system. To date, software products developed for the SAP system in the field of manufacturing all connect with SAP via interfaces. Each organization develops a product using a programming tool such as Java, .NET or the like. When wanting to update SAP, an interface is sent to the SAP system. Usually feedback is received on a control screen which has been developed for this function (receiving feedback). The feedback details errors such as an incorrect work order, no stock for the item issued, no batch for the item, etc. This method of working results in incomplete data as well as the SAP system not being updated in real time, because correcting the errors usually takes an amount of time not immediately available and the repairs are therefore performed during spare time.

The SFIC system has been developed as a platform that “sits on top” of the SAP system and knows how to execute all updates on the SAP system online, where the previously mentioned feedback elements are corrected online as if the SFIC system is the SAP system itself, as the SFIC system minors the ERP system, and data is gleaned from the minor in real-time. No interfaces are necessary.

To give the user the impression of working on the SAP system, the immediate innovative system has been developed as a mirror (EMM 101) of the SAP system, except that the SFIC has flexible, friendly, intuitive, graphically enabled tools which do not exist on the SAP system and which cannot be designed with the same flexibility on the SAP system. Exemplarily, at least 40 customized records built on the SFIC system allow maximum flexibility, and to fully simulate the online SAP system.

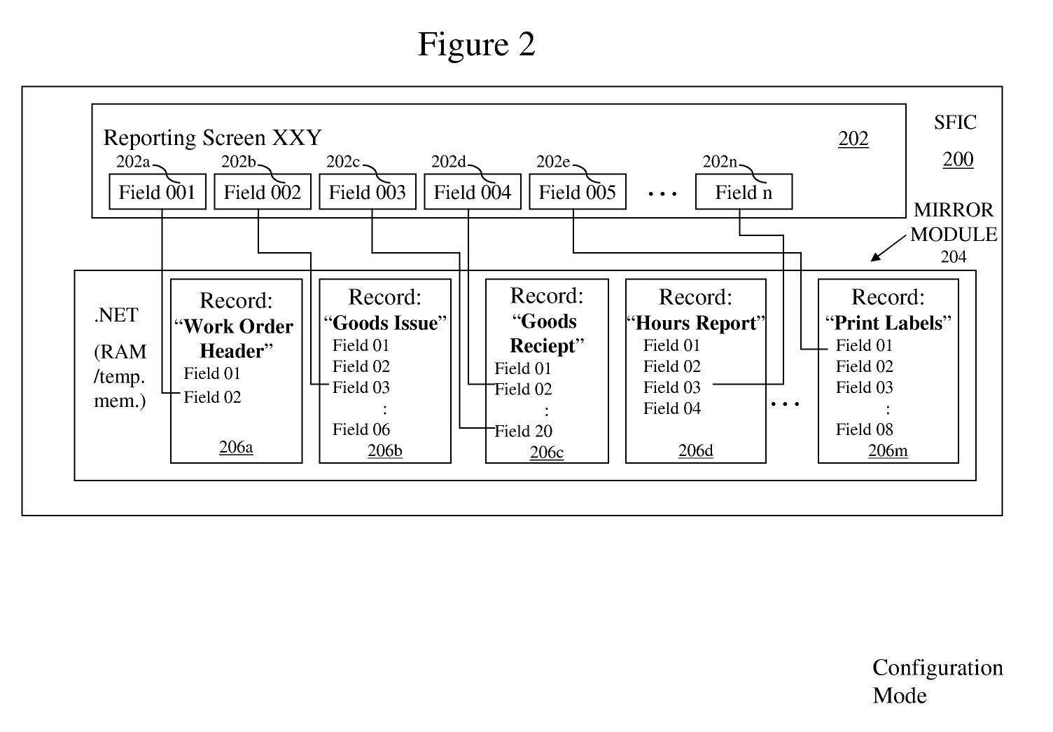

FIG. 2 depicts a schematic diagram of the SFIC system interfacing with the SAP system. FIG. 2 contains exemplary components for illustrative purposes. SFIC system 200 includes two modules, as mentioned above, UFM 202 and EMM 204. UFM 202 has two modes of activity, a Configuration Mode and an Application mode. In the Configuration Mode, a user creates/configures/customizes reporting screens. Here, exemplary reporting screen XXY 202 is being configured/customized/created. As mentioned previously, top-end users who are not necessarily system programmers and/or who do not necessarily have in depth knowledge of the ERP system are able to create/configure/customize reporting screens as desired, according to the specific needs of the function they wish to fulfill. This is unique to the immediate invention. The exemplary reporting screen XXY has n of fields 202a-202n. The ERP Mirror Module (EMM) 204 is a set of temporary logical files created in the .NET system temporary memory (e.g. RAM). EMM 204, that knows all about SAP, and has data fields similar to SAP and lets the user link to the specific data fields he needs. In more detail, the files contain records arranged and grouped according to category/subject. For example the “Work Order Header” record 206a contains two fields. Data-field 01, for example, may contain the ‘order number’ (not shown) and data-field 02 the ‘material number’ (not shown). All the relevant records (containing the relevant data-fields) are created in temporary memory of the .NET system as explained above. Only some of these fields are chosen by the top-user who creates or customizes the reporting screen. The user defines a reporting field as desired. SFIC system 200 determines which data field should be linked/connected to the newly defined reporting field. In the exemplary illustration, reporting field 001 202a of the reporting screen XXY is related/linked/coupled to data field 02 of Work Order Header record 206a. The information temporarily stored in specific field of the EMM is ‘logically connected’, linked, pointed to, or any similar coupling mechanism, that is to say made available, to the relevant reporting screen reporting field online in real-time. The same is true for reporting field 002 202b and field 03 of the Goods Issue record 206b. Further in the current exemplarily illustration, reporting field 003 202c is connected to Field 20 of Goods Receipts record 206c and reporting field 004 202d is connected to field 02 of Goods Receipts record 206c. Reporting field 005 202e is connected to Field 01 of the Print Labels record 206m and reporting field n 202n is connected to Field 03 of the Hours Report record 206d. A reporting screen does not necessarily contain reporting fields connected to data fields of every record. Once the desired reporting screens are configured, the user switches to Application Mode, to begin using the innovative system. A user can created or modify reporting screens at any time according to need.

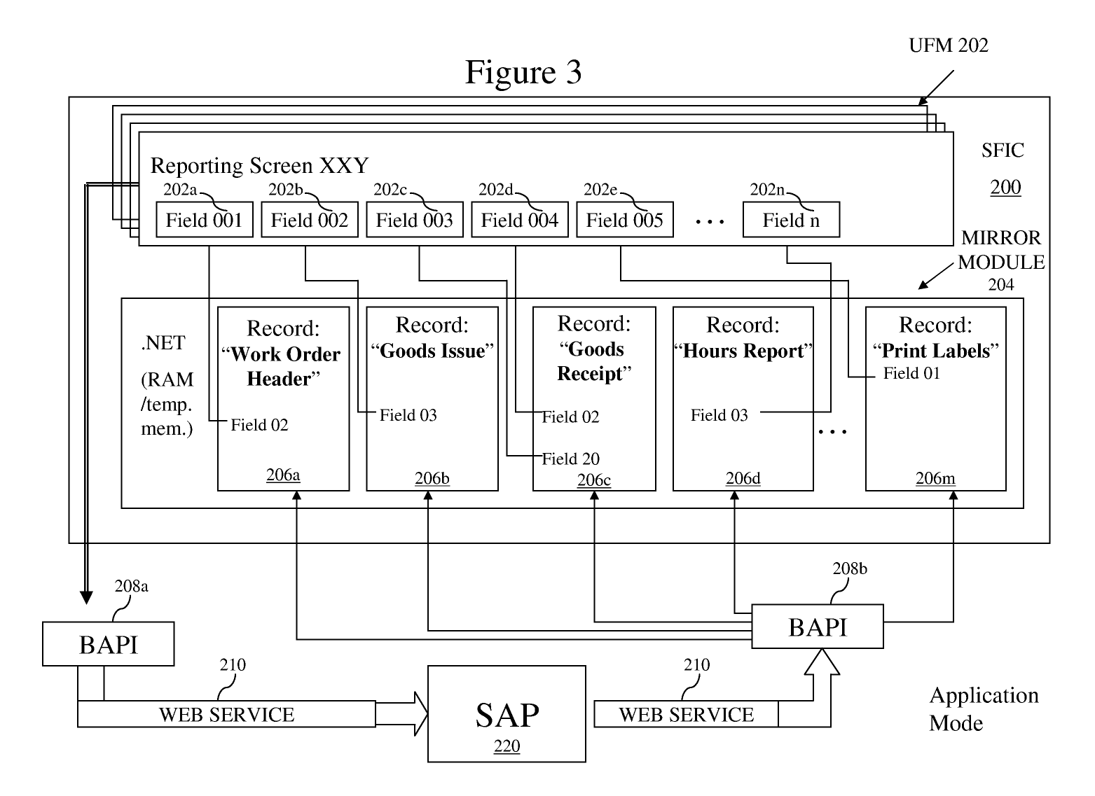

FIG. 3 illustrates the innovative system on Application mode. Here various reporting screens have been configured in UFM 202 and are interacting with the ERP system 220. For each configured reporting screen, only those data-fields related to the given reporting screen are loaded into temporary memory. Potentially, when accessing a reporting screen, the ERP data can be automatically updated with current data in the ERP system. In Application mode, the user can effect various interactions/actions with the ERP data and/or user-data via the reporting screens. Interaction with ERP-data and/or user-data includes receiving user-data from a user, outputting ERP-data from the EMM, manipulating said user-data, manipulating said ERP-data or any combination of the aforementioned. As mentioned previously, manipulating data can include displaying, printing, calculating, representing a graphic form or any other relevant manipulation of the data.

The manner of communication of data between SFIC system 200 and the ERP system 220 is described above in general term regarding FIG. 1, and detailed further here. For example, a DR or Data Update (DU) is entered into the relevant field of reporting screen XXY. A BAPI 208a is sent via the web services 210 to the SAP system 220 to update or request information. The updated or requested data is returned to the SFIC system 200 in a BAPI 208b via the web services 210. BAPI 208b updates the relevant fields in the EMM 204. All up-to-date information is available to the user for direct access from the EMM 204 as if working on the SAP system online in real-time with constantly information.

It is important to point out that no data is saved in a .NET database, only temporary logic files containing relevant data are created and later discarded. Many controlling bodies, such as the FDA (Food and Drug Administration) do not allow databases containing product-manufacturing data to be duplicated, therefore, the .NET system has no active database.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A system for simplifying communication between a user and an Enterprise Resource Planning (ERP) system, comprising:
(a) a User-Facing Module (UFM) operable to send user-data, received from the user, to the ERP system; and interact with ERP-data substantially equivalent to parallel data in the ERP system; and
(b) an ERP Minor Module (EMM), for temporarily storing said ERP-data, received from the ERP system, and organizing said ERP-data so as to enable said interaction with said UFM.

2. The system of claim 1, wherein said EMM includes a group of at least one temporary file containing a set of at least one record having a set of at least one data field, wherein each said at least one data field contains data substantially equivalent to data in a respective parallel data field in the ERP system.

3. The system of claim 2, wherein said UFM has:
(a) a Configuration Mode, for configuring at least one reporting screen; and
(b) an Application Mode, for effecting said interaction with said ERP data using said at least one configured reporting screen.

4. The system of claim 3, wherein each said at least one reporting screen that is configured is selected from the group consisting of a new reporting screen and a pre-configured reporting screen.

5. The system of claims 3, wherein said configuring of said at least one reporting screen includes the steps of:
(A) customizing at least one reporting field, in said reporting screen; and
(B) logically connecting each said at least one reporting field to a respective said data field temporarily saved in said EMM.

6. The system of claim 3, wherein, in said Application mode, said interaction includes at least one action selected from the group of:
(i) receiving said user-data from the user;
(ii) outputting said ERP-data from said EMM;
(iii) manipulating said user-data; and
(iv) manipulating said ERP-data.

7. The system of claim 1, wherein said user-data is data selected from the group of:
(i) a data request (DR) for requesting data from the ERP system, and
(ii) a data update (DU) for updating data on the ERP system.

8. The system of claim 1, wherein said sending of said user-data includes the steps of:
(i) converting said user-data into an ERP-recognized data set; and
(ii) sending said ERP-recognized data set to the ERP system via an ERP recognized data transfer service.

9. The system of claim 8, wherein said receiving of said ERP-data from the ERP system by said EMM includes the steps of:
(i) receiving an ERP recognized data set sent via said ERP recognized data transfer service; and
(ii) organizing said ERP recognized data set into ERP-data useful to said UFM.

10. The system of claim 8, wherein said ERP-recognized data set is a Business Application Programming Interface (BAPI).

11. The system of claim 9, wherein said data transfer service is a web service of an Application Server.

12. A method of simplifying communication between a user and an Enterprise Resource Planning (ERP) system, comprising the steps of:
(a) mapping the ERP system;
(b) categorizing relevant elements mapped on the ERP system;
(c) for each category, creating a record containing a set of at least one data field; and
(d) copying parallel data from the ERP system to said set of at least one data field.

13. The method of claim 12, further comprising the steps of:
(e) configuring a reporting screen having a group of at least one reporting field; and
(f) logically connecting each of said at least one reporting field to a respective said data field.

14. The method of claim 13, further comprising the step of:
(g) manipulating said copied parallel data via said group of at least one reporting field.
